(19) United States
(12) Patent Application Publication
(10) Pub. No.: US 2012/0014770 A1
(43) Pub. Date: Jan. 19, 2012

(54) SUBSTRATE CONVEYANCE APPARATUS, ELECTRONIC DEVICE MANUFACTURING SYSTEM, AND ELECTRONIC DEVICE MANUFACTURING METHOD

(75) Inventors: Kazuhito Watanabe, Tama-shi (JP); Yukihito Tashiro, Chofu-shi (JP); Naoyuki Nozawa, Inagi-shi (JP); Daisuke Kobinata, Tokyo (JP)

(73) Assignee: CANON ANELVA CORPORATION, Kawasaki-shi (JP)

(21) Appl. No.: 13/182,578

(22) Filed: Jul. 14, 2011

(30) Foreign Application Priority Data
Jul. 16, 2010 (JP) 2010-162192

(51) Int. Cl. B25J 9/00; B25J 18/00; B25J 15/06; B25J 11/00

(52) U.S. Cl. 414/225.01; 414/226.05; 901/27; 901/14

(57) ABSTRACT

A substrate conveyance apparatus includes a first driving shaft, an arm portion having one end connected to the first driving shaft, a substrate holding unit capable of holding a substrate, and a connecting portion that connects the other end of the arm portion and the substrate holding unit. The connecting portion includes a rotating support portion that supports the substrate holding unit rotatably with respect to the arm portion, and a moving unit that moves the substrate holding unit upward or downward with respect to the arm portion in the direction of the rotating shaft about which the substrate holding unit is rotated by the rotating support portion.

### BACKGROUND OF THE INVENTION

1. Field of the Invention

The present invention relates to a substrate conveyance apparatus, an electronic device manufacturing system, and an electronic device manufacturing method and, more particularly, to a substrate conveyance apparatus which conveys a semiconductor wafer substrate, a liquid crystal display, a solar cell substrate, or an optical communication substrate, and an electronic device manufacturing system and an electronic device manufacturing method using the substrate conveyance apparatus.

2. Description of the Related Art

A conventional substrate conveyance robot (for example, Japanese Patent Laid-Open No. 10-128692) will be explained with reference to FIG. 7. The substrate conveyance robot includes a substrate holding device 774 capable of holding a substrate, a first arm 772 rotatable by driving an outer shaft 790, a belt 775 and pulleys 778a and 778b in a predetermined diameter, which transmit the rotation of an inner shaft 780, and a second arm 773. One end of the second arm 773 is rotatably supported by the first arm 772. The other end of the second arm 773 rotatably supports the substrate holding device 774. Rotating the first arm 772 and the second arm 773 by predetermined angles while synchronizing their driving enables to implement the linear operation of the substrate holding device 774 in the x-y plane.

Japanese Patent Laid-Open No. 8-506771 proposes an arm constructed without any belt. The arm of the substrate conveyance robot disclosed in Japanese Patent Laid-Open No. 8-506771 synchronously rotates the outer and inner shafts in the same direction, thereby changing the direction of the substrate conveyance robot. In addition, the first and second arms are rotated by predetermined angles while synchronizing their driving, like Japanese Patent Laid-Open No. 10-128692, thereby implementing the linear operation. There also exists a substrate conveyance robot having a vertical mechanism that vertically moves its substrate holding device to transfer the substrate. The substrate process in each process chamber is done in a vacuum environment. Hence, the substrate conveyance robot is designed to be operable without deteriorating the vacuum environment of a conveyance chamber that functions as a vacuum chamber.

The substrate conveyance robot shown in FIG. 7 includes a rotating driving mechanism that operates the first arm 772 and a rotating driving mechanism that operates the second arm 773 (an upper motor 700 and a lower motor 710). To cope with the vacuum, a housing 730 having a vacuum partition function is provided between the rotor and the stator. A bellows 795 covers the outer shaft 790 between the housing 730 and the vacuum chamber to hold the hermetic state in the housing. The rotors (an inner shaft rotor 740 and an outer shaft rotor 750) having permanent magnets are arranged while being aligned with the stators (an inner shaft stator 745 and an outer shaft stator 755) fixed to the housing 730. The inner shaft 780 to be driven by the lower motor 710 and the outer shaft 790 to be driven by the upper motor 700 are arranged to be coaxial. The upper motor 700 and the lower motor 710 are provided in series in the vertical direction. Rotational position detection sensors (an inner shaft encoder 760 and an outer shaft encoder 765) are provided to detect the rotational position and angle of each driving shaft.

The substrate conveyance robot 1000 rotates the rotors (the inner shaft rotor 740 and the outer shaft rotor 750) by predetermined angles based on the power supplied to the stators (the inner shaft stator 745 and the outer shaft stator 755). The first arm 772 and the second arm 773 are rotated by predetermined angles while synchronizing their driving, thereby conveying the substrate placed on the substrate holding device 774.

A vertical driving unit 781 of the substrate conveyance robot includes a vertical driving rotor 782, a vertical driving stator 784, a vertical driving shaft 786, and a movable connecting member 788 (nut) fixed to the housing 730. A rotational position detection sensor (vertical driving shaft encoder 796) is provided to detect the rotational position and angle of the vertical driving shaft 786. When the vertical driving rotor 782 rotates by a predetermined angle based on power supplied to the vertical driving stator 784, the vertical driving shaft 786 rotates. As the vertical driving shaft 786 rotates, the movable connecting member 788 (nut) moves along the vertical driving shaft 786 upward or downward. The movement of the movable connecting member 788 (nut) is transmitted via the housing 730. The vertical driving unit 781 can thus wholly raise or lower the upper motor 700, the lower motor 710, the inner shaft 780, the outer shaft 790, the first arm 772, the second arm 773, and the substrate holding device 774. The upward or downward movement of the substrate holding device 774 is guided by a sliding member 791 (linear guide) provided inside a general housing 799. The vertical driving unit 781 controls the rotation of the vertical driving shaft 786, thereby positioning the substrate holding device 774.

However, in the conventional substrate conveyance robot, the constituent elements to be moved vertically include heavy components such as the upper motor 700, the lower motor 710, the inner shaft 780, the outer shaft 790, the first arm 772, and the second arm 773 whose total weight exceeds, for example, several ten kg. For this reason, to vertically move all the constituent elements to be vertically moved, a driving source for generating a larger driving force and a linear guide that is rigid enough to ensure vertical movement with less vibrations are necessary. This problematically leads to the necessity of a larger driving source, higher linear guide capability, and upsizing of the apparatus.

From the viewpoint of reducing the weight of the constituent elements to be vertically moved, it is difficult to give a sufficient rigidity to the constituent elements. For this reason, a vibration generated upon vertical movement readily propagates, via the upper motor 700, the lower motor 710, the inner shaft 780, and the outer shaft 790, to the first arm 772, the second arm 773, and the substrate holding device 774 whose structures are less rigid than those of the motors and the shafts. If transfer is done using the substrate holding device 774 that is vibrating, a shift of the substrate support position may make it impossible to accurately place the substrate on the substrate holder of the processing apparatus. For reliable substrate transfer between the processing apparatus and the substrate conveyance robot, the substrate transfer operation needs to be stopped until the vibration transmitted to the substrate holding device 774 sufficiently attenuates. To do this, however, the tact time of the substrate conveyance robot needs to be long.

For utilization in the vacuum environment, a movable seal having a larger diameter is necessary. However, since the resistance of the movable seal acts as a kind of spring reaction force, a driving source of larger capacity is required. As the movable seal, a bellows is normally used. However, the bellows is a high-value-added product and leads to an increase in the cost as a whole.

### SUMMARY OF THE INVENTION

The present invention has been made in consideration of the above-described problems, and provides a substrate conveyance apparatus capable of downsizing without requiring a larger driving source and linear guide capability. Alternatively, the present invention provides a substrate conveyance apparatus capable of shortening the tact time of the transfer operation. Otherwise, the present invention provides a substrate conveyance apparatus capable of reducing the cost of the apparatus.

According to one aspect of the present invention, there is provided a substrate conveyance apparatus comprising: a first driving shaft; an arm portion having one end connected to the first driving shaft; a substrate holding unit capable of holding a substrate; and a connecting portion that connects the other end of the arm portion and the substrate holding unit, wherein the connecting portion comprises: a rotating support portion that supports the substrate holding unit rotatably with respect to the arm portion; and a moving unit that moves the substrate holding unit upward or downward with respect to the arm portion in a direction of a rotating shaft about which the substrate holding unit is rotated by the rotating support portion.

According to another aspect of the present invention, there is provided a substrate conveyance apparatus comprising: a first driving shaft; a first arm portion that has one end connected to the first driving shaft and is rotatable in synchronism with the first driving shaft; a second driving shaft that is provided to be coaxial with the first driving shaft and is rotatable independently; a second arm portion that is rotatably supported at the other end of the first driving shaft and is rotatable in synchronism with the second driving shaft; a substrate holding unit capable of holding a substrate; and a connecting portion that connects the second arm portion and the substrate holding unit, wherein the connecting portion comprises: a rotating support portion that supports the substrate holding unit rotatably with respect to the second arm portion; and a moving unit that moves the substrate holding unit upward or downward with respect to the second arm portion in a direction of a rotating shaft about which the substrate holding unit is rotated by the rotating support portion.

According to the present invention, it is possible to provide a substrate conveyance apparatus capable of downsizing without requiring a larger driving source and linear guide capability.

Alternatively, it is possible to provide a substrate conveyance apparatus capable of shortening the tact time of the transfer operation. Otherwise, it is possible to provide a substrate conveyance apparatus capable of reducing the cost of the apparatus.

Further features of the present invention will become apparent from the following description of exemplary embodiments with reference to the attached drawings.

### BRIEF DESCRIPTION OF THE DRAWINGS

FIG. 1A is a block diagram showing the functional arrangement of a substrate conveyance robot according to the first embodiment;

FIG. 1B is a perspective view showing the overall arrangement of the arm portion of the substrate conveyance robot according to the first embodiment;

FIGS. 2A to 2F are views for explaining the operation of the substrate conveyance robot according to the first embodiment;

FIG. 3A is a view showing a state in which the moving mechanism of the connecting portion of the substrate conveyance robot according to the first embodiment has moved upward;

FIG. 3B is a view showing a state in which the moving mechanism of the connecting portion has moved downward;

FIG. 4 is a view for explaining the connecting portion of a substrate conveyance robot according to the second embodiment;

FIG. 5A is a block diagram showing the functional arrangement of a substrate conveyance robot according to the third embodiment;

FIG. 5B is a view for explaining the schematic structure of the substrate conveyance robot according to the third embodiment;

FIGS. 6A to 6H are views for explaining the transfer operation of the substrate conveyance robot according to the first embodiment; and

FIG. 7 is a view for explaining a conventional substrate conveyance robot.

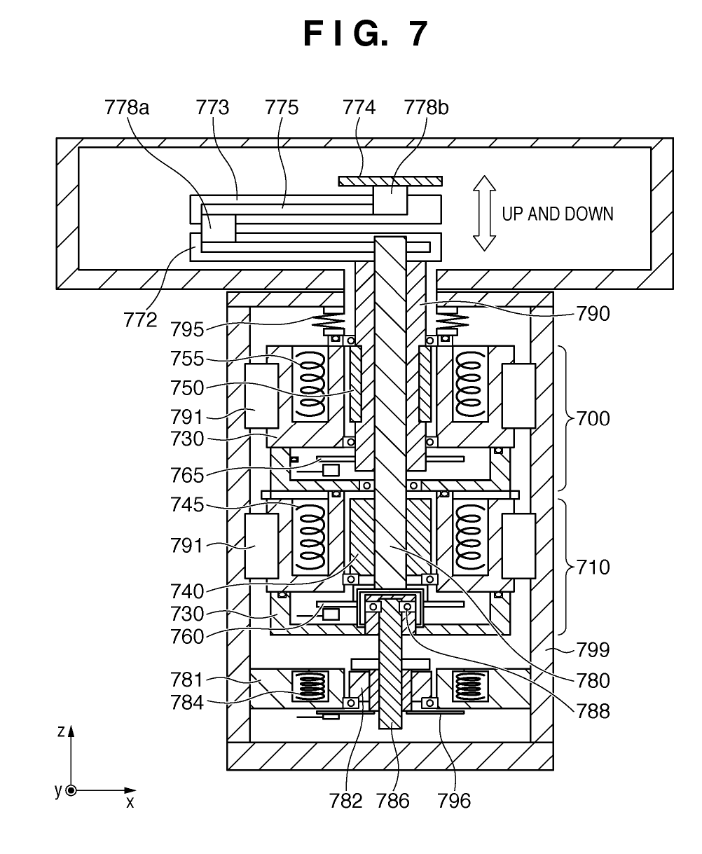

### DESCRIPTION OF THE EMBODIMENTS

Preferred embodiments of the present invention will now be described in detail with reference to the accompanying drawings. Note that the constituent elements described in the embodiments are merely examples. The technical scope of the present invention is determined by the scope of claims and is not limited by the following individual embodiments.

### First Embodiment

### (Functional Arrangement of Substrate Conveyance Apparatus)

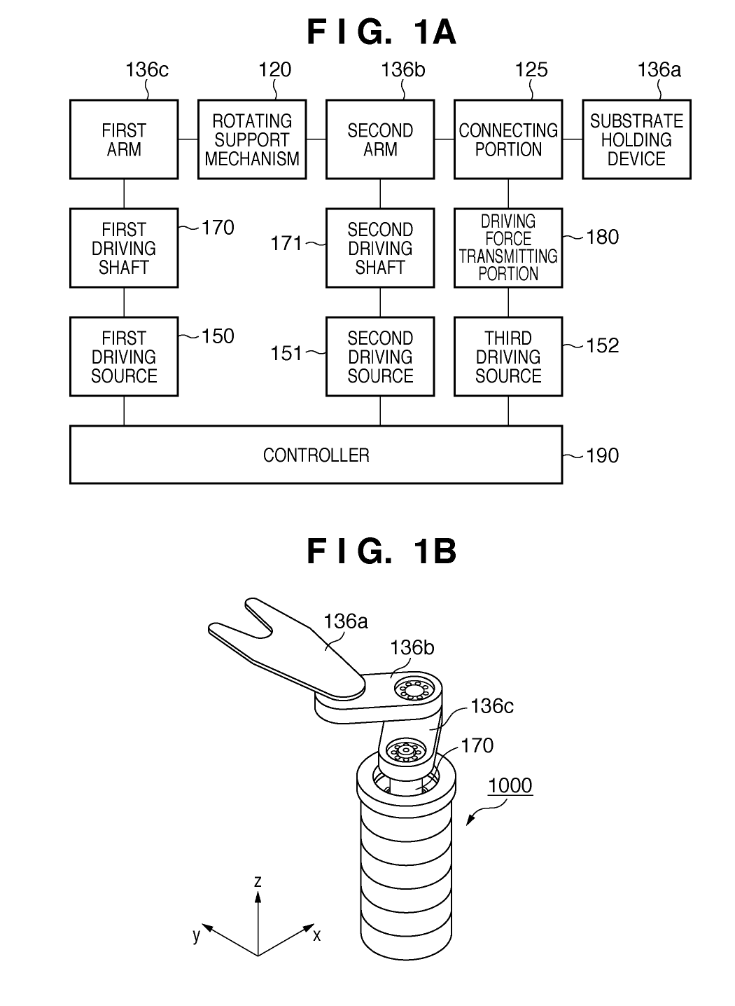

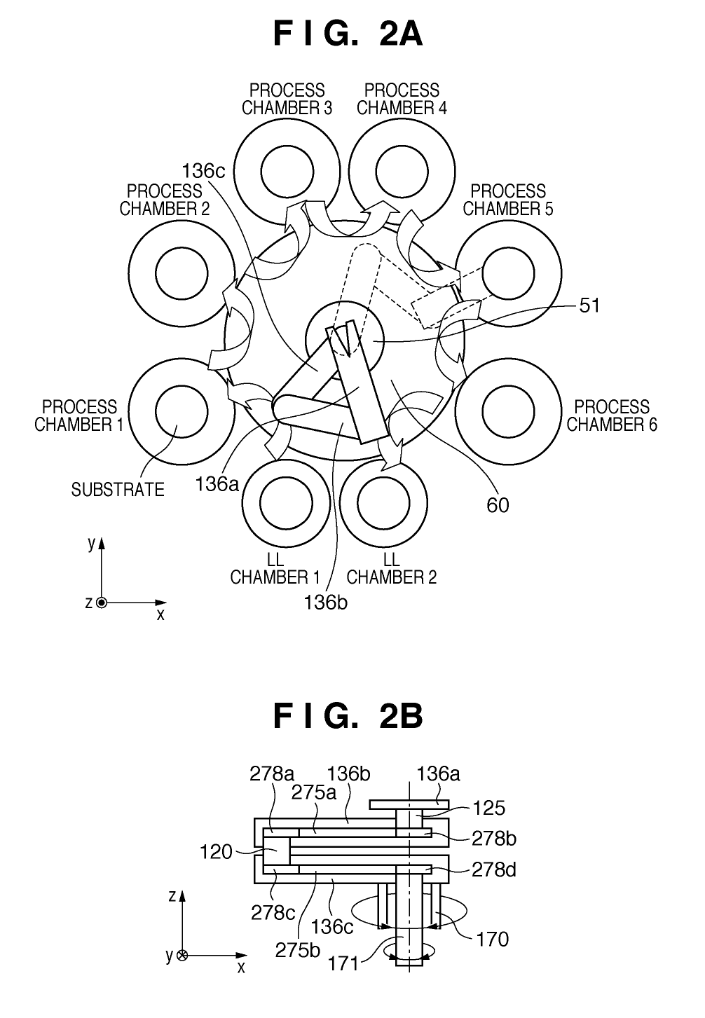

The arrangement of a substrate conveyance apparatus (to be also referred to as a “substrate conveyance robot” hereinafter) according to the first embodiment of the present invention will be described with reference to FIGS. 1A and 1B. FIG. 1A is a block diagram showing the functional arrangement of the substrate conveyance robot. FIG. 1B is a perspective view showing the overall arrangement of the arm portion of the substrate conveyance robot.

A substrate conveyance robot 1000 includes a substrate holding unit (to be referred to as a “substrate holding device 136a” hereinafter) on which a substrate can be placed. A first driving source 150 (first motor) installed outside the vacuum chamber generates a rotation driving force (first driving force) and transmits it to a first arm portion (to be referred to as a “first arm 136c” hereinafter) via a first driving shaft 170. A second driving source 151 (second motor) installed outside the vacuum chamber generates a rotation driving force (second driving force) and transmits it to a second arm portion (to be referred to as a “second arm 136b” hereinafter) via a second driving shaft 171. The first driving shaft 170 has a hollow cylindrical shape, and the second driving shaft 171 has a columnar shape. The second driving shaft 171 is arranged in the first driving shaft 170 so that they are coaxial.

First detection information obtained from the encoder of the first driving source 150 (first motor) and second detection information obtained from the encoder of the second driving source 151 (second motor) are input to a controller 190 that controls the substrate conveyance robot 1000. The controller 190 functioning as a control unit can control rotation of the first driving shaft 170 and rotation of the second driving shaft 171 based on the input first detection information and second detection information.

One end of the first arm 136c is connected to the first driving shaft 170. A rotating support mechanism 120 (rotating support portion) is provided on the other end side of the first arm 136c. One end of the second arm 136b is connected to the rotating support mechanism 120. The rotating support mechanism 120 supports the second arm 136b rotatably with respect to the first arm 136c.

A connecting portion 125 is provided on the other end side of the second arm 136b. The substrate holding device 136a is connected to the connecting portion 125. The connecting portion 125 supports the substrate holding device 136a rotatably with respect to the second arm 136b.

The connecting portion 125 includes a rotating support mechanism that holds the substrate holding device 136a rotatably with respect to the second arm 136b, and a moving mechanism capable of moving the substrate holding device 136a upward or downward. The arrangement of the moving mechanism will be described later in detail.

A third driving source 152 generates a driving force for operating the moving mechanism of the connecting portion 125. The driving force from the third driving source 152 is transmitted to the moving mechanism of the connecting portion 125 via a driving force transmitting portion 180. The controller 190 can independently control the operations of the first driving source 150, the second driving source 151, and the third driving source 152.

As shown in the perspective view of FIG. 1B, one end of the first arm 136c of the substrate conveyance robot 1000 is connected to be rotatable in synchronism with rotation of the first driving shaft 170. The other end side of the first arm 136c is connected to one end of the second arm 136b via the rotating support mechanism 120 (FIG. 1A). The other end of the second arm 136b is connected to the substrate holding device 136a via the connecting portion 125 (FIG. 1A). The second driving shaft is provided in the first driving shaft 170 to be coaxial with it. The second arm 136b can rotate in synchronism with the second driving shaft.

(Operation of Substrate Conveyance Robot)

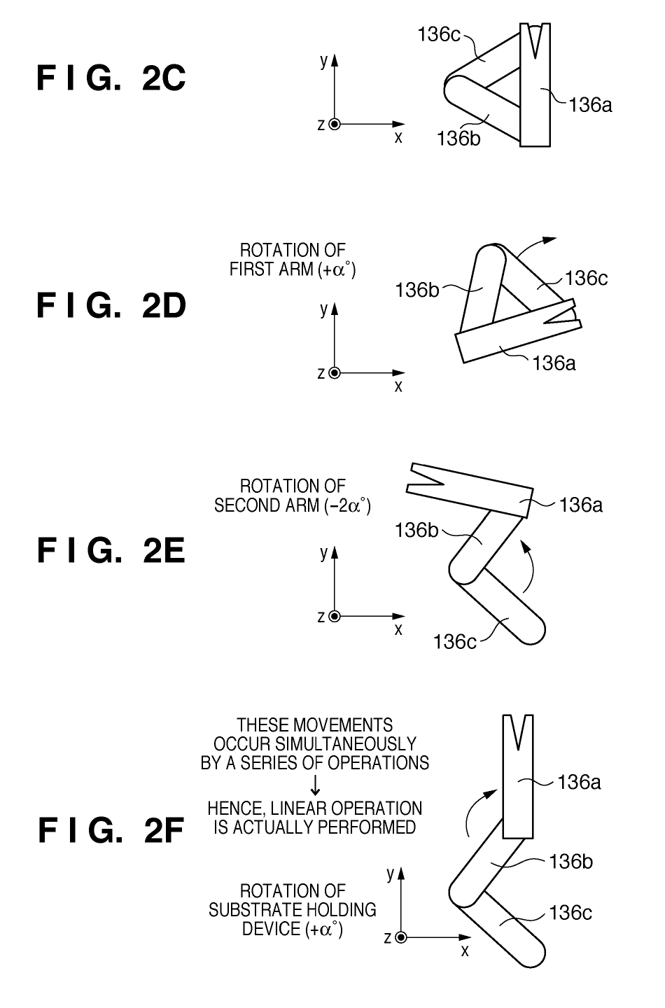

The substrate conveyance robot can supply substrates to a plurality of processing apparatuses and collect substrates processed by the processing apparatuses from them. The operation of the substrate conveyance robot will be explained with reference to FIGS. 2A to 2F. A plurality of processing apparatuses (to be referred to as “process chambers” hereinafter) 1 to 6 shown in FIG. 2A are radially arranged around the substrate conveyance robot 1000. The substrate conveyance robot 1000 is arranged in a conveyance chamber 60 to convey a substrate carried out from a load lock chamber LL1 to each of process chambers 1 to 6. The substrate processed in each process chamber is finally discharged from a load lock chamber LL2.

FIG. 2B is a view for schematically explaining the internal structure of the first arm 136c and the second arm 136b of the substrate conveyance robot. The first arm 136c and the second arm 136b have a hollow structure. Pulleys 278a and 278c are provided on the rotating shaft of the rotating support mechanism 120. A pulley 278b is provided on the rotating shaft of the connecting portion 125. A belt 275a loops between the pulley 278b and the pulley 278a. A pulley 278d is provided at one end of the second driving shaft 171. A belt 275b loops between the pulley 278d and the pulley 278c. Rotation of the second driving shaft 171 is transmitted to the rotating shaft of the rotating support mechanism 120 via the pulley 278d and the belt 275b. Rotation of the rotating shaft of the rotating support mechanism 120 is then transmitted to the rotating shaft of the connecting portion 125 via the pulley 278a and the belt 275a. The ratio of rotation of the shafts can be adjusted by arbitrarily setting the diameter of each pulley.

The controller 190 of the substrate conveyance robot 1000 can control to ensure a linear track of the substrate holding device 136a by performing the rotating)(+α°) operation of the first arm 136c (FIG. 2D), the rotating)(−2α°) operation of the second arm 136b (FIG. 2E), and the rotating)(+α°) operation of the substrate holding device 136a (FIG. 2F) simultaneously from the state shown in FIG. 2C.

When the first driving shaft 170 (outer shaft) is rotated while keeping the second driving shaft 171 (inner shaft) connected to the belt 275b fixed (unrotated), the first arm 136c rotates (by +α°) about the central axis. The belt connected to the pulley having a predetermined number of dents inside the first arm 136c acts to operate the second arm 136b by a predetermined angle (for example, twofold: −2α°) in the direction reverse to that of the rotation of the first arm 136c. The substrate holding device 136a is configured to be rotatable by the same angle)(+α°) in the same direction as the first arm 136c. This enables a linear operation of linearly moving the substrate holding device 136a. This linear operation allows to convey the substrate placed on the substrate holding device 136a into a process chamber. When the process of the substrate in the process chamber has ended, the substrate conveyance robot 1000 collects the substrate from the process chamber by the linear operation. The first driving shaft 170 and the second driving shaft 171 of the substrate conveyance robot 1000 are rotated synchronously in the same direction to change the direction of the substrate conveyance robot 1000. After that, the substrate conveyance robot 1000 can transfer the substrate to another process chamber.

(Arrangement of Connecting Portion 125)

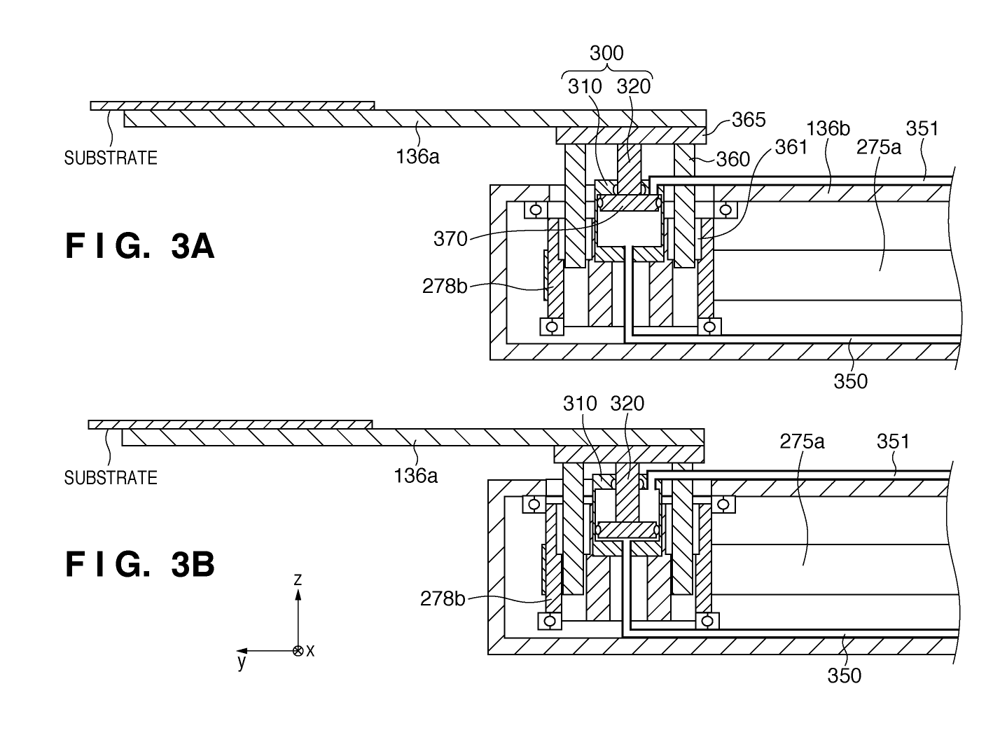

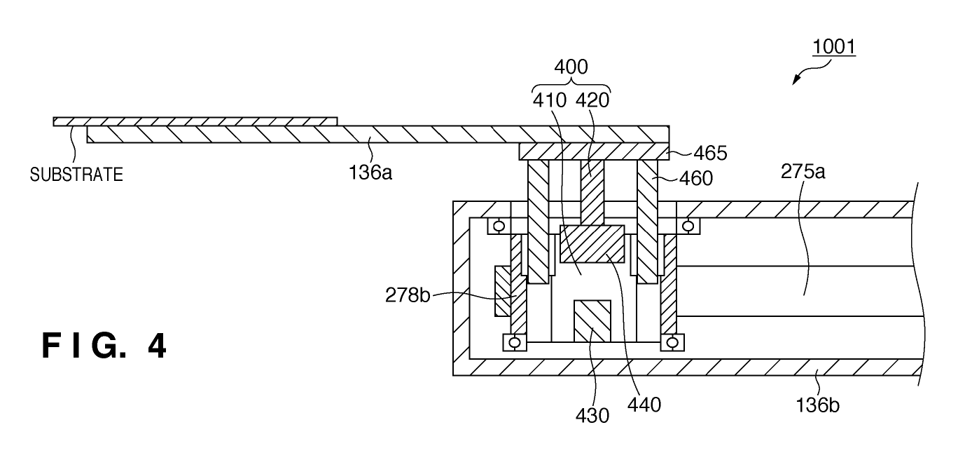

The detailed arrangement of the connecting portion 125 that is a feature of this embodiment will be described next with reference to FIGS. 3A and 3B. FIG. 3A is a view showing a state in which the moving mechanism of the connecting portion 125 has moved upward. FIG. 3B is a view showing a state in which the moving mechanism of the connecting portion 125 has moved downward. The belt 275a loops on the pulley 278b functioning as the rotating support portion of the connecting portion 125. The belt 275a can rotate the pulley 278b about the z-axis. An air cylinder 300 functioning as the moving unit of the connecting portion 125 is provided at the center of the rotating shaft of the pulley 278b.

The main constituent elements of the air cylinder 300 are a hollow cylinder case (to be simply referred to as a “case portion 310” hereinafter), a shaft portion (to be referred to as a “shaft 320” hereinafter), and a disc-shaped valve element portion (to be referred to as a “valve element 370” hereinafter). The interior of the case portion 310 is partitioned by the valve element 370 into a first internal space on the lower surface side of the valve element 370 and a second internal space on the upper surface side of the valve element 370. One end of the shaft 320 is connected to the disc-shaped valve element 370 inside the case portion 310. The other end of the shaft 320 is connected to the substrate holding device 136a via a member 365 outside the case portion 310. The case portion 310 of the air cylinder 300 is fixed to the pulley 278b such that the axis of the shaft 320 matches the rotating shaft center of the pulley 278b. The pulley 278b has a recessed portion formed in its inner wall to fix the case portion 310 of the air cylinder 300. The case portion 310 is fitted in the recessed portion and fixed.

Pipes 350 (first pipe) and 351 (second pipe) formed from flexible tubes are connected to the case portion 310. The pipes 350 and 351 can be led, for example, through the second arm 136b and the first arm 136c which have a hollow structure and then through the first driving shaft 170 having a cylindrical structure and connected to solenoid valves and an air supply unit provided outside the substrate conveyance robot 1000. The pipes 350 and 351 may be led along the outer walls of the second arm 136b, the first arm 136c, and the like and connected to solenoid valves and an air supply unit provided outside the substrate conveyance robot 1000.

The pipe 350 (first pipe) connects the air supply unit to the first internal space of the case portion 310, and the pipe 351 (second pipe) connects the air supply unit to the second internal space of the case portion 310. In this embodiment, the solenoid valves and the air supply unit function as the third driving source 152. The pipes 350 and 351 to be used to supply or exhaust air function as the driving force transmitting portion 180.

The controller 190 can control the solenoid valves to supply air from the air supply unit to one or both of the pipes 350 and 351. A regulator can control the air supplied from the air supply unit to a predetermined pressure. For example, a regulator is provided on each of the pipes 350 and 351 to set different pressure values and supply air of different pressures to the first internal space and the second internal space of the case portion 310 via the pipes 350 and 351.

(Upward Movement of Shaft 320)

When air of a predetermined pressure is supplied from the pipe 350 to the first internal space of the case portion 310, the lower surface side of the valve element 370 is lifted by the pressure difference to the air pressure on the upper surface side upon air inflow, and the shaft 320 moves upward. When the valve element 370 is moved by the pressure difference, the shaft 320 can smoothly move up to the stroke end. It is therefore possible to more effectively suppress vibrations.

The controller 190 may open the solenoid valve connected to the pipe 351 to exhaust air from the second internal space of the case portion 310 via the pipe 351 along with the rise of the valve element 370. The shaft 320 can move faster than when moving the valve element 370 by the pressure difference. When the shaft 320 moves upward, the substrate holding device 136a rises. The upward movement of the shaft 320 is guided by a sliding member 361 (guide bush) movable on a linear rail 360. The sliding member 361 (guide bush) need only be so rigid as to stably guide the load of the substrate holding device 136a to be moved, for example, an object weighing about 1 kg.

Rotary joints are usable to connect the pipes 350 and 351 to the case portion 310. When the pulley 278b rotates, the air cylinder 300 fixed to it also rotates. Using the rotary joints allows to fix the connection positions of the pipes 350 and 351 to predetermined positions. Hence, is it possible to stably supply or exhaust air without damaging the pipes 350 and 351.

(Downward Movement of Shaft 320)

When air of a predetermined pressure is supplied from the pipe 351 to the second internal space of the case portion 310, the upper surface side of the valve element 370 is pushed down by the pressure difference from the air pressure on the lower surface side upon air inflow, and the shaft 320 moves downward. The controller 190 may open the solenoid valve connected to the pipe 350 to exhaust air from the first internal space via the pipe 350 along with the lowering of the valve element 370. When the shaft 320 moves downward, the substrate holding device 136a lowers. The upward or downward movement of the substrate holding device 136a is guided by the sliding member 361 (guide bush) movable on the linear rail 360. The sliding member 361 (guide bush) enables movement only in the vertical direction with respect to the pulley 278b and restricts movement in other directions. The sliding member 361 is not limited to the guide bush if it enables movement only in the vertical direction and restricts movement in other directions. For example, a slide bearing or the like is usable.

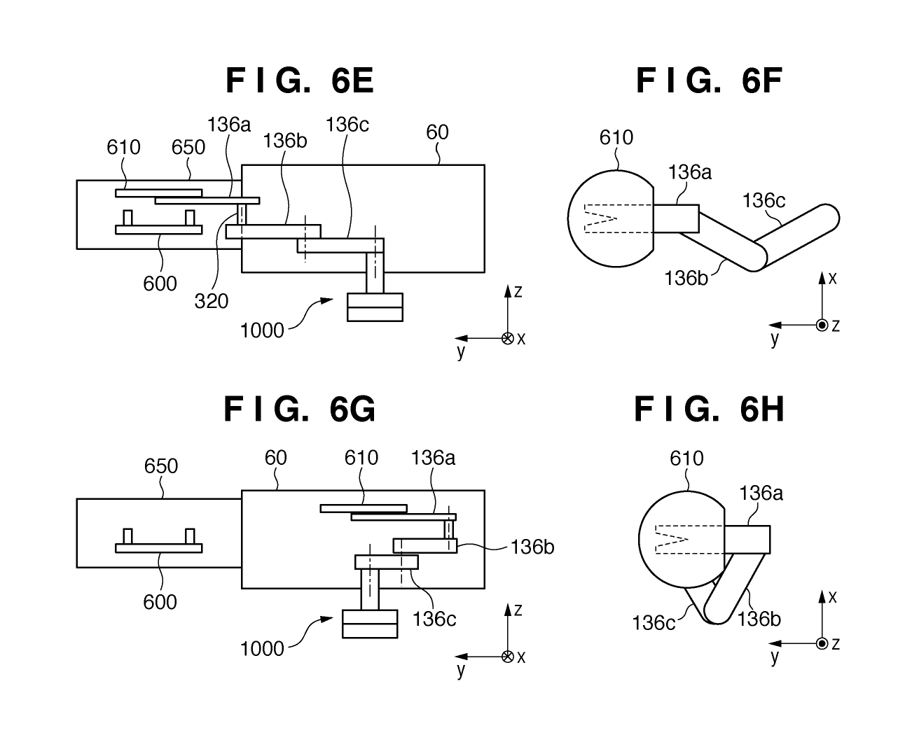

An example of the transfer operation of the substrate conveyance robot 1000 when collecting a substrate 610 from a process chamber 650 will be explained next with reference to FIGS. 6A to 6H. FIG. 6A shows a state in which the substrate conveyance robot 1000 is at rest in the conveyance chamber 60. At this time, the substrate 610 is placed on a substrate holder 600 provided in the process chamber 650. FIG. 6B illustrates the substrate conveyance robot 1000 viewed from the upper side in the z-axis direction.

FIG. 6C shows a state in which the first arm 136c and the second arm 136b of the substrate conveyance robot 1000 operate to put the substrate holding device 136a into the process chamber 650. In this state, the substrate holding device 136a is located between the substrate holder 600 and the substrate 610. FIG. 6D illustrates the substrate conveyance robot 1000 in FIG. 6C viewed from the upper side in the z-axis direction.

FIG. 6E shows a state in which the shaft 320 of the air cylinder 300 moves upward to move the substrate holding device 136a upward. In this state, the substrate 610 is transferred from the substrate holder 600 to the substrate holding device 136a. FIG. 6F illustrates the substrate conveyance robot 1000 in FIG. 6E viewed from the upper side in the z-axis direction.

FIG. 6G shows a state in which the first arm 136c and the second arm 136b operate to retreat the substrate holding device 136a into the conveyance chamber 60 in the risen state of the shaft 320 of the air cylinder 300. The substrate 610 is transferred from the substrate holder 600 to the substrate holding device 136a and collected to the side of the conveyance chamber 60 in this state. FIG. 6H illustrates the substrate conveyance robot 1000 in FIG. 6G viewed from the upper side in the z-axis direction.

When an operation sequence reverse to the processing procedure described with reference to FIGS. 6A to 6H is executed, the substrate conveyance robot 1000 can supply the substrate 610 to the substrate holder 600 in the process chamber 650. When transferring the substrate 610, only the substrate holding device 136a moves upward, as shown in FIG. 6E. This makes it possible to provide a substrate conveyance apparatus capable of downsizing without requiring a larger driving source and linear guide capability. Since only the substrate holding device 136a moves upward, vibrations can be suppressed as compared to the case in which the entire substrate conveyance robot moves upward. Even if vibrations are generated, the vibration (amplitude) generated when moving the substrate holding device 136a weighing about 1 kg is smaller than that generated when moving the entire substrate conveyance robot 1000. Hence, the time required for sufficient attenuation of the vibration of the substrate holding device 136a is much shorter than the time required for sufficient attenuation of the vibration generated when moving the entire substrate conveyance robot 1000. This allows to shorten the tact time of the transfer operation of the substrate conveyance robot 1000. The effects implemented in this embodiment can also be implemented in the embodiments to be described below.

### Second Embodiment

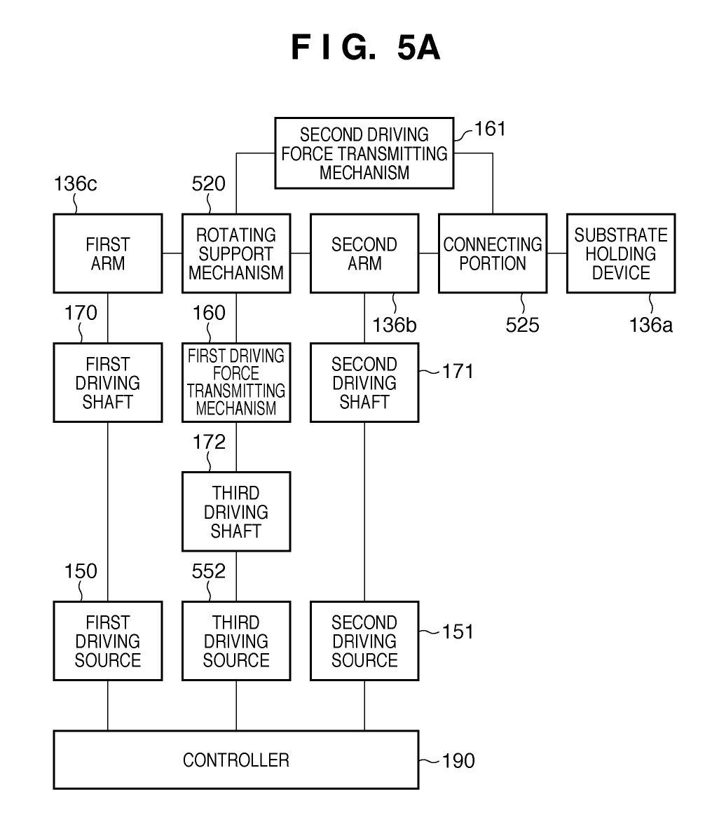

The arrangement of a substrate conveyance robot 1001 according to the second embodiment will be described next. In the first embodiment, an example in which the air cylinder 300 is used as a component of the connecting portion 125 has been described. The second embodiment is different from the first embodiment in that an electromagnet unit 400 is used. The basic arrangement is the same as that of the first embodiment, and a repetitive description thereof will be omitted. The arrangement of a connecting portion 125 of the substrate conveyance robot according to the second embodiment will be described with reference to FIG. 4. A belt 275a loops on a pulley 278b functioning as the rotating support mechanism of the connecting portion 125. The belt 275a can rotate the pulley 278b about the z-axis. The electromagnet unit 400 functioning as the moving mechanism of the connecting portion 125 is provided at the center of the rotating shaft of the pulley 278b.

The electromagnet unit 400 includes a hollow case portion (to be referred to as a “case 410” hereinafter), a shaft portion (to be referred to as a “shaft 420” hereinafter), a magnet coil portion (to be referred to as a “magnet coil 430” hereinafter), and a magnet portion (to be referred to as a “permanent magnet 440” hereinafter). The shaft 420 has one end connected to a substrate holding device 136a outside the case 410 and the other end connected to the permanent magnet 440 inside the case 410. The magnet coil 430 is arranged on the bottom surface in the case 410 so as to face the permanent magnet 440.

The case 410 of the electromagnet unit 400 is fixed to the pulley 278b such that the axis of the shaft 420 matches the rotating shaft center of the pulley 278b.

A controller 190 can control a current to be supplied from an external power supply to the magnet coil 430. A wiring cable configured to supply a predetermined current controlled by the controller 190 is connected to the magnet coil 430. In this case, the external power supply functions as a third driving source 152, and the wiring cable functions as a driving force transmitting portion 180.

The wiring cable passes, for example, through a second arm 136b and a first arm 136c which have a hollow structure and then through a first driving shaft 170 having a cylindrical structure and connected to the external power supply provided outside the substrate conveyance robot 1001. The controller 190 controls the current of the external power supply to cause the magnet coil 430 to generate a magnetic field of the same polarity as that of the permanent magnet 440. The shaft 420 moves upward due to the repulsion force generated between the magnet coil 430 and the permanent magnet 440, and the substrate holding device 136a connected to the shaft 420 thus moves upward.

To lower the substrate holding device 136a, the controller 190 can control the current of the external power supply to cause the magnet coil 430 to generate a magnetic field of the polarity opposite to that of the permanent magnet 440. The substrate holding device 136a may be lowered by turning off the current to be applied to the magnet coil 430, as a matter of course.

The upward movement and downward movement of the substrate holding device 136a are guided by a sliding member 461 movable on a linear rail 460. As the sliding member 461, for example, a guide bush or a slide bearing can be used, as in the first embodiment.

### Third Embodiment

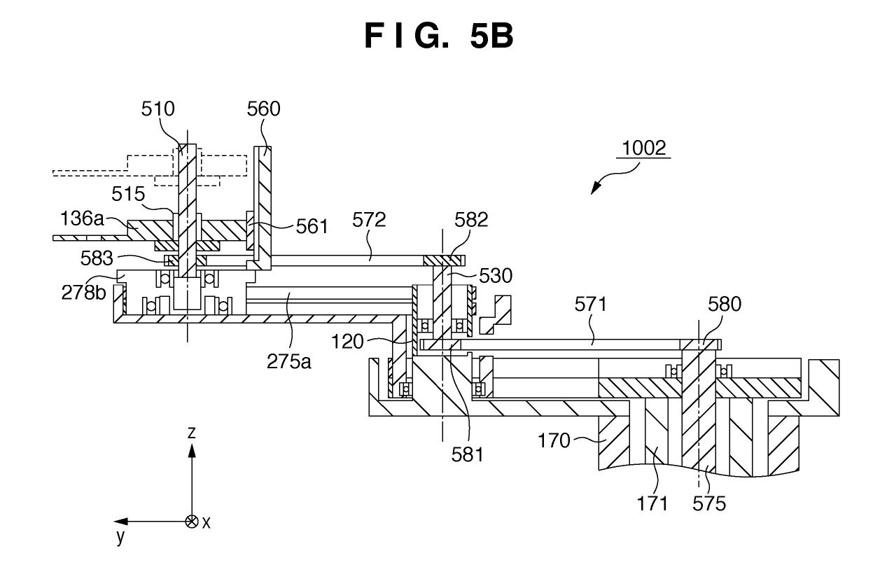

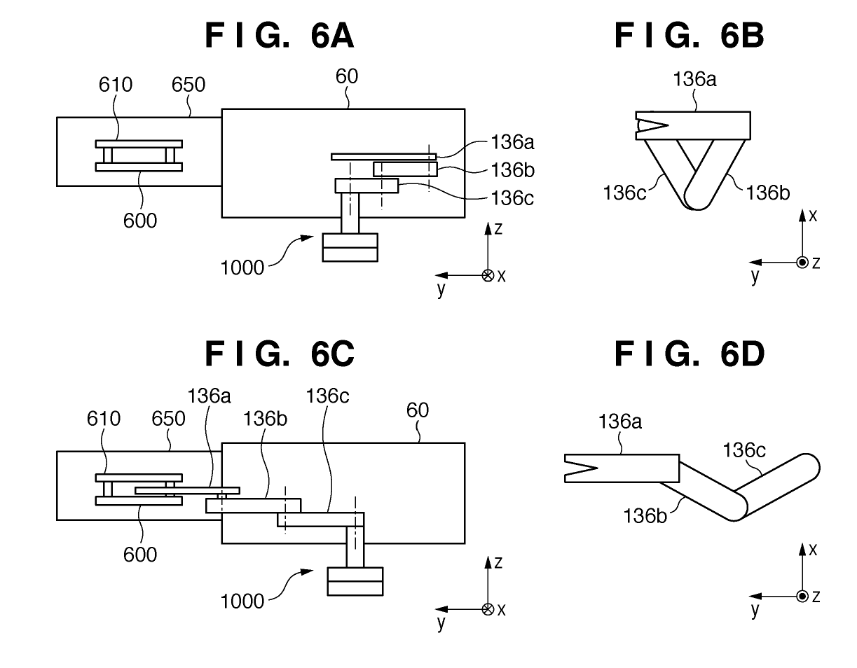

The arrangement of a substrate conveyance robot 1002 according to the third embodiment will be described next with reference to FIGS. 5A and 5B. In the first embodiment, an example in which the air cylinder 300 is used as a component of the connecting portion 125 has been described. The third embodiment is different from the first embodiment in that a ball screw is used.

(Functional Arrangement of Substrate Conveyance Apparatus)

FIG. 5A is a block diagram showing the functional arrangement of a substrate conveyance robot 1002 (FIG. 5B). A first driving source 150 installed outside the vacuum chamber generates a rotation driving force (first driving force) and transmits it to a first arm 136c via a first driving shaft 170.

A second driving source 151 installed outside the vacuum chamber generates a rotation driving force (second driving force) and transmits it to a second arm 136b via a second driving shaft 171. The first driving shaft 170 and the second driving shaft 171 have a hollow cylindrical shape, and a third driving shaft 172 has a columnar shape. The second driving shaft 171 is arranged in the first driving shaft 170, and the third driving shaft 172 is arranged in the second driving shaft 171 so that they are coaxial.

First detection information obtained from the encoder of the first driving source 150 (first motor) is input to a controller 190. Second detection information obtained from the encoder of the second driving source 151 (second motor) and third detection information obtained from the encoder of a third driving source 552 (third motor) are also input to the controller 190. The controller 190 can control rotation of the first driving shaft 170, rotation of the second driving shaft 171, and the third driving shaft 172 based on the input first detection information, second detection information, and third detection information.

One end of the first arm 136c is connected to the first driving shaft 170. A rotating support mechanism 520 is provided on the other end of the first arm 136c. One end of the second arm 136b is connected to the rotating support mechanism 520. The rotating support mechanism 520 supports the second arm 136b rotatably with respect to the first arm 136c.

A connecting portion 525 is provided on the other end of the second arm 136b. The substrate holding device 136a is connected to the connecting portion 525. The connecting portion 525 supports the substrate holding device 136a rotatably with respect to the second arm 136b.

The connecting portion 525 includes a rotating support mechanism 520 that holds the substrate holding device 136a rotatably with respect to the second arm 136b, and a moving mechanism capable of moving the substrate holding device 136a upward or downward.

A third driving source 552 generates a driving force (third driving force) for operating the moving mechanism of the connecting portion 525. The rotating support mechanism 520 includes a rotating shaft (relay rotating shaft) configured to relay the driving force (third driving force). The driving force (third driving force) is transmitted to the moving mechanism of the connecting portion 525 via a first driving force transmitting mechanism 160, the rotating shaft (relay rotating shaft), and a second driving force transmitting mechanism 161.

(Arrangement of Connecting Portion 525 (FIG. 5A))

The connecting portion 525 of the substrate conveyance robot 1002 (FIG. 5B) according to this embodiment is formed using a ball screw as a moving means. The ball screw includes a screw shaft 510 and a nut 515 as constituent elements. A belt 275a loops on a pulley 278b functioning as the rotating support portion of the connecting portion 525. The belt 275a can rotate the pulley 278b about the z-axis. The screw shaft 510 of the ball screw functioning as the moving unit of the connecting portion 525 is provided at the center of the rotating shaft of the pulley 278b. The axis of the screw shaft 510 of the ball screw and the rotating shaft center of the pulley 278b are coaxial. The nut 515 (moving member) of the ball screw moves along the direction of the screw shaft 510 in accordance with rotation of the screw shaft 510.

In this embodiment, the second driving shaft 171 has a cylindrical shape. The third driving shaft 172 configured to drive the screw shaft 510 of the ball screw is provided in the second driving shaft 171. The first driving shaft 170, the second driving shaft 171, and the third driving shaft 172 are coaxial. The third driving shaft 172 has one end connected to the third driving source 552 and the other end provided with a pulley 580. Pulleys 581 and 582 are provided on a rotating shaft 530 (relay rotating shaft) of the rotating support mechanism 520. A pulley 583 is provided on one end of the screw shaft 510 of the ball screw. A belt 571 loops between the pulley 580 and the pulley 581. A belt 572 loops between the pulley 582 and the pulley 583. Rotation of the third driving shaft 172 is transmitted to the rotating shaft 530 (relay rotating shaft) of the rotating support mechanism 520 via the pulley 580, the belt 571, and the pulley 581. Rotation of the rotating shaft 530 (relay rotating shaft) of the rotating support mechanism 520 is then transmitted to the screw shaft 510 of the ball screw via the pulley 582, the belt 572, and the pulley 583.

When the screw shaft 510 of the ball screw rotates, the nut 515 of the ball screw moves upward or downward in accordance with the direction of rotation. The substrate holding device 136a is attached to the nut 515. The substrate holding device 136a moves upward or downward as the nut 515 moves upward or downward. A linear guide 560 is attached to the pulley 278b not to rotate the substrate holding device 136a with respect to the pulley 278b. The linear guide 560 has a columnar or rectangular section. The substrate holding device 136a comes into contact with a sliding member 561 movable on the linear guide 560 to regulate its rotation.

### Fourth Embodiment

In each of the above embodiments, a substrate conveyance robot including an articulated arm mechanism with first and second arms has been described. However, a substrate conveyance robot having only one arm may include a mechanism for vertically moving the substrate holding device. A driving source having only one driving shaft is used, and the substrate holding device is provided on an end portion of the first arm via the vertical mechanism. In this case, the substrate holding device need not rotate with respect to the arm. Hence, the connecting portion includes only the vertical mechanism of the substrate holding device.

The substrate conveyance apparatus includes a driving shaft (first driving shaft) connected to a driving source (first driving source), an arm portion having one end connected to the driving shaft (first driving shaft), a substrate holding device arranged on the other end side of the arm portion, and a connecting portion that connects the other end of the arm portion and the substrate holding device. The connecting portion includes, as features, a rotating support mechanism that supports the substrate holding device rotatably with respect to the arm portion, and a moving mechanism that moves the substrate holding device upward or downward with respect to the arm portion in the direction of the rotating shaft about which the substrate holding device is rotated by the rotating support mechanism. As the moving mechanism, for example, a ball screw including a screw shaft and a nut is usable. The moving mechanism includes a moving member (nut) that moves along the direction of the rotating shaft in accordance with the rotation of the screw shaft provided to be coaxial with the rotating shaft of the rotating support mechanism.

The substrate conveyance apparatus further includes a second driving shaft connected to a second driving source independent of the driving source, and a driving force transmitting mechanism that transmits rotation of the second driving shaft to the screw shaft. As a feature, the substrate holding device moves upward or downward in accordance with movement of the moving member that moves as the screw shaft rotates.

According to the above-described embodiments, it is possible to provide a substrate conveyance apparatus capable of downsizing without requiring a larger driving source and linear guide capability.

Alternatively, it is possible to provide a substrate conveyance apparatus capable of shortening the tact time of the transfer operation. Otherwise, it is possible to provide a substrate conveyance apparatus capable of reducing the cost of the apparatus.

(Electronic Device Manufacturing System and Device Manufacturing Method)

The substrate conveyance robot according to the embodiments is applicable to, for example, an electronic device manufacturing system as shown in FIG. 2A. Process chambers 1 to 6 are radially arranged around the substrate conveyance robot 1000, 1001, or 1002 (to be referred to as the “substrate conveyance robot 1000” hereinafter) (FIG. 2A). When the substrate holding device 136a is linearly operated based on the rotating operation of the first arm 136c and the second arm 136b, the substrate conveyance robot 1000 can convey a substrate to each process chamber. When the process of the substrate in the process chamber has ended, the substrate conveyance robot 1000 collects the substrate from the process chamber and transfers it to another process chamber where the next process is performed. The single substrate conveyance robot 1000 can convey substrates to the plurality of processing apparatuses (process chambers 1 to 6). The electronic device manufacturing system according to this embodiment includes the substrate conveyance robot 1000 described in the above embodiment, and at least one processing apparatus that executes a device manufacturing process for a substrate conveyed by the substrate conveyance robot 1000.

An electronic device manufacturing method includes conveying a substrate using the substrate conveyance robot 1000, and executing a device manufacturing process in at least one processing apparatus for a substrate conveyed in the conveying the substrate. Electronic devices to be manufactured by the electronic device manufacturing system and the electronic device manufacturing method include at least one of, for example, a semiconductor device, a liquid crystal display, a solar cell, and an optical communication device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-162192, filed Jul. 16, 2010, which is hereby incorporated by reference herein in its entirety.

What is claimed is:

1. A substrate conveyance apparatus comprising:
a first driving shaft;
an arm portion having one end connected to said first driving shaft;
a substrate holding unit capable of holding a substrate; and
a connecting portion that connects the other end of said arm portion and said substrate holding unit,
wherein said connecting portion comprises:
a rotating support portion that supports said substrate holding unit rotatably with respect to said arm portion; and
a moving unit that moves said substrate holding unit upward or downward with respect to said arm portion in a direction of a rotating shaft about which said substrate holding unit is rotated by said rotating support portion.

2. A substrate conveyance apparatus comprising:
a first driving shaft;
a first arm portion that has one end connected to said first driving shaft and is rotatable in synchronism with said first driving shaft;
a second driving shaft that is provided to be coaxial with said first driving shaft and is rotatable independently;
a second arm portion that is rotatably supported at the other end of said first driving shaft and is rotatable in synchronism with said second driving shaft;
a substrate holding unit capable of holding a substrate; and
a connecting portion that connects said second arm portion and said substrate holding unit,
wherein said connecting portion comprises:
a rotating support portion that supports said substrate holding unit rotatably with respect to said second arm portion; and
a moving unit that moves said substrate holding unit upward or downward with respect to said second arm portion in a direction of a rotating shaft about which said substrate holding unit is rotated by said rotating support portion.

3. The apparatus according to claim 2, wherein said moving unit includes a moving member that moves along the direction of the rotating shaft in accordance with rotation of a screw shaft provided to be coaxial with the rotating shaft of said rotating support portion,
the substrate conveyance apparatus further comprises:
a third driving shaft that is rotatable independently of said first driving shaft and said second driving shaft; and
a driving force transmitting portion that transmits rotation of said third driving shaft to the screw shaft, and
said substrate holding unit moves upward or downward in accordance with movement of said moving member that moves as the screw shaft rotates.

4. The apparatus according to claim 1, wherein said moving unit includes a moving member that moves along the direction of the rotating shaft in accordance with rotation of a screw shaft provided to be coaxial with the rotating shaft of said rotating support portion,
the substrate conveyance apparatus further comprises:
a second driving shaft that is rotatable independently of said first driving shaft; and
a driving force transmitting portion that transmits rotation of said second driving shaft to the screw shaft, and
said substrate holding unit moves upward or downward in accordance with movement of said moving member that moves as the screw shaft rotates.

5. The apparatus according to claim 1, wherein said moving unit comprises:
a hollow case portion fixed to said rotating support portion;
a shaft portion provided to be coaxial with a rotating shaft of said rotating support portion;
a disc-shaped valve element that is connected to one end of said shaft portion inside said case portion and partitions an internal space of said case portion into a first internal space and a second internal space;
an air supply unit capable of supplying air of a predetermined pressure;
a first pipe that connects said air supply unit and the first internal space of said case portion;
a second pipe that connects said air supply unit and the second internal space of said case portion; and
a control unit that controls supply of the air from said air supply unit to the internal space of said case portion via at least one of said first pipe and said second pipe,
wherein the other end of said shaft portion is connected to said substrate holding unit outside said case portion,
when the air is supplied to the first internal space via said first pipe under the control of said control unit, said valve element is lifted by the air so as to move said substrate holding unit connected to said shaft portion upward, and
when the air is supplied to the second internal space via said second pipe under the control of said control unit, said valve element is pushed down by the air so as to move said substrate holding unit connected to said shaft portion downward.

6. The apparatus according to claim 1, wherein said moving unit comprises:
a hollow case portion fixed to said rotating support portion;
a shaft portion provided to be coaxial with a rotating shaft of said rotating support portion, and having one end connected to said substrate holding unit outside said case portion;
a magnet portion connected to the other end said shaft portion inside said case portion; and
a magnet coil portion arranged on a bottom surface in said case portion so as to face said magnet portion.

7. The apparatus according to claim 6, further comprising a control unit that controls a current to be supplied to said magnet portion,
wherein said control unit controls the current to cause said magnet coil portion to generate a magnetic field repelling said magnet portion, and
said shaft portion is lifted by a repulsion force generated between said magnet coil portion and said magnet portion so as to move said substrate holding unit connected to said shaft portion upward.

8. An electronic device manufacturing system comprising:
a substrate conveyance apparatus of claim 1; and
at least one processing apparatus that executes a device manufacturing process for a substrate conveyed by said substrate conveyance apparatus.

9. An electronic device manufacturing method comprising:
conveying a substrate using a substrate conveyance apparatus of claim 1; and
executing a device manufacturing process in at least one processing apparatus for a substrate conveyed in the conveying the substrate.
